(19) United States
(12) Patent Application Publication
(10) Pub. No.: US 2025/0249344 A1
(43) Pub. Date: Aug. 7, 2025

(54) PROGRAM, METHOD, INFORMATION PROCESSING DEVICE, AND SYSTEM

(71) Applicant: The Pokémon Company, Tokyo (JP)

(72) Inventors: Keita HIROBE, Tokyo (JP); Takuya HASHIMOTO, Tokyo (JP); Satoki NAKAMURA, Tokyo (JP); Shunsuke TAKAGI, Tokyo (JP)

(73) Assignee: The Pokémon Company, Tokyo (JP)

(21) Appl. No.: 19/186,641

(22) Filed: Apr. 23, 2025

Related U.S. Application Data
(63) Continuation of application No. PCT/JP2023/037797, filed on Oct. 19, 2023.

(30) Foreign Application Priority Data
Oct. 27, 2022 (JP) 2022-172295

(51) Int. Cl. A63F 1/06; G06F 16/27

(52) U.S. Cl. CPC A63F 1/06; G06F 16/27

(57) ABSTRACT

A program is to be executed by a computer including a processor and a memory. The program causes the processor to perform the steps of storing information about a plurality of digital cards such that even identical digital cards are uniquely identifiable; storing information about card use, in which any one of the plurality of digital cards is used, in association with the used digital card; and presenting, when receiving selection of any one of the plurality of digital cards, the information about the card use that is associated with the card.

### CROSS-REFERENCE TO RELATED APPLICATIONS

This application is a continuation of international application no. PCT/JP2023/037797, filed Oct. 19, 2023, which claims priority to Japanese application no. 2022-172295, filed Oct. 27, 2022. The entire contents of both prior applications are hereby incorporated by reference.

### TECHNICAL FIELD

The present disclosure relates to a program, a method, an information processing device, and a system.

### BACKGROUND

Recently, digital trading card games (TCGs) played using digital cards have received attention.

### CITATION LIST

### Patent Literature

[PTL 1] Japanese Patent Application Laid-open No. 2021-146030

### SUMMARY

### Technical Problems

In digital TCGs, owned digital cards are combined to construct a deck for play. Since a digital TCG has a large number of cards lacking material substance, it is difficult to feel attachment for the cards even in a TCG battle using a deck.

In PTL 1, a battle game is played such that a plurality of game objects can appear, and the battle result of the battle game is provided to a user terminal for each user. A user cheers game objects and obtains a bonus on the basis of the result of a battle game and the degree of cheering at the end of the battle game between the game objects.

In PTL 1, a server system sets a fan group for each of all characters that can appear in a battle game, and determines a fan group to be assigned to each user. However, in PTL 1, any concept like a card constituting a deck is not present.

In an exemplary embodiment, the present disclosure describes a technique that allows a digital TCG to leave attachment to cards.

### Solutions to Problems

A program is to be executed by a computer including a processor and a memory. The program causes the processor to perform the steps of: storing information about a plurality of digital cards such that even identical digital cards are uniquely identifiable; storing information about card use, in which any one of the digital cards is used, in association with the used digital card; and presenting, when receiving selection of any one of the digital cards, the information about the card use that is associated with the card.

### Advantageous Effects

According to the present disclosure, a digital TCG can leave attachment to cards.

### BRIEF DESCRIPTION OF DRAWINGS

FIG. 1 shows a phase for preparing a TCG battle according to one or more aspects of the present disclosure.

FIG. 2 shows a phase for starting a TCG battle according to one or more aspects of the present disclosure.

FIG. 3 shows a phase in which each user is proceeding with a TCG battle.

FIG. 4 is a block diagram illustrating an example of the overall configuration of a system.

FIG. 5 is a block diagram of a configuration example of a terminal device shown in FIG. 4.

FIG. 6 shows an example of the functional configuration of a server.

FIG. 7 shows the data structure of card information.

FIG. 8 shows the data structure of deck information.

FIG. 9 shows the data structure of a user information table.

FIG. 10 shows the data structure of a card master table.

FIG. 11 shows the data structure of a deck information table.

FIG. 12 shows the data structure of a battle information table.

FIG. 13 shows the data structure of a bonus information table.

FIG. 14 shows the data structure of a card management table.

FIG. 15 is an explanatory drawing showing an operation example of the terminal device and the server when a user purchases a card.

FIG. 16 is an explanatory drawing showing an operation example of the terminal device and the server when a card used by the user in a battle is managed.

FIG. 17 is an explanatory drawing showing an operation example of the terminal device and the server when a card supported by the user is managed.

FIG. 18 is a schematic view showing a display example of a display of the terminal device.

FIG. 19 is a schematic view showing a display example of the detailed information of a card displayed on the display.

FIG. 20 is a schematic view showing another display example of the detailed information of the card displayed on the display.

FIG. 21 is a block diagram illustrating a basic hardware configuration of a computer.

### DETAILED DESCRIPTION

Hereinafter, the present disclosure will be described with reference to the drawings. In the following description, the same parts are denoted by the same reference numerals. The names and functions thereof are also the same. Thus, a detailed description thereof will not be repeated.

### <Overview>

A program according to an exemplary embodiment of the present disclosure is a program for managing the use history of digital cards owned by a user. In an exemplary embodiment, the use of digital cards includes, for example, the use of a deck constructed by a plurality of organized digital cards or the assistance of other players using a deck selected associated with digital cards. The program offers a predetermined bonus to a user who owns digital cards, on the basis of the use history of the digital cards.

An outline of a TCG according to a present embodiment will be first described below. Thereafter, a card management system will be described.

### <0 Outline of TCG>

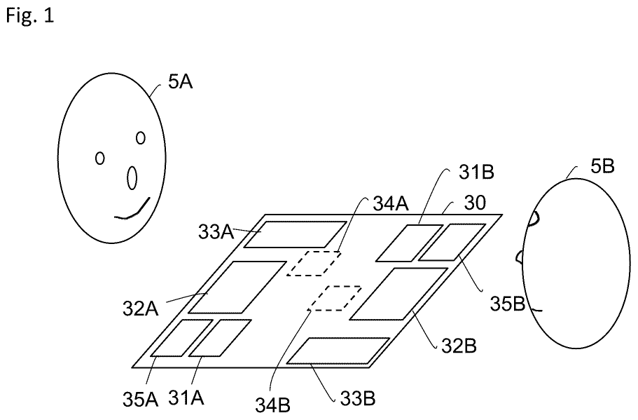

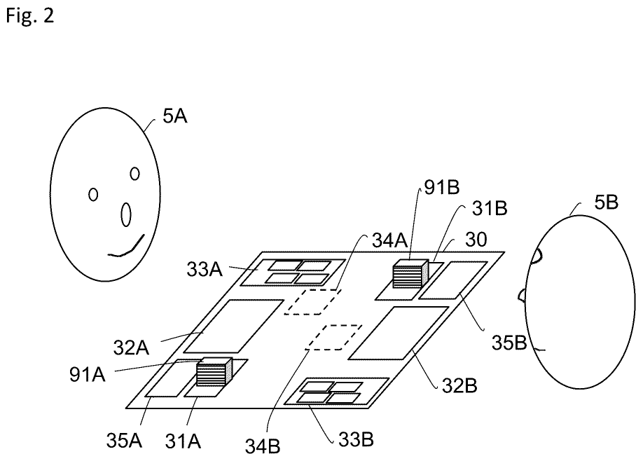

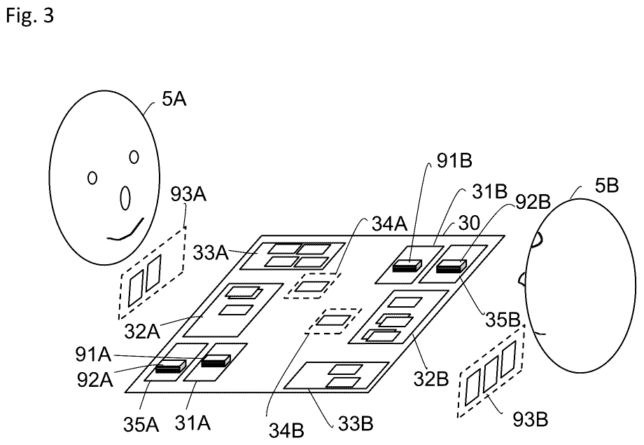

FIG. 1 shows a phase for preparing a TCG battle according to the present embodiment. FIG. 2 shows a phase for starting a TCG battle according to the present embodiment. FIG. 3 shows a phase in which each user is proceeding with a TCG battle.

A user places a play mat 30 and fights a TCG battle using a deck constructed by combining cards to be used for the TCG battle.

### <0.1 Configuration of Play Mat 30>

Referring to FIG. 1, various items used by each user in a TCG battle will be described below. As shown in FIG. 1, the play mat 30 is placed between a user 5A (first user) and a user 5B (second user) to start a TCG battle between the user 5A and the user 5B. The play mat 30 is placed to arrange cards included in the deck. Each user places cards as a stock or the like on the play mat 30 and proceeds with a TCG battle while adding cards to the hand from the stock.

The configuration of the play mat 30 will be described below. The play mat 30 includes, for example, a mat that indicates a position where a card is placed. The play mat 30 includes, for example, a stock placement part 31A and a stock placement part 31B (hereinafter may be generically called “stock placement part 31”), a prepared-card placement part 32A and a prepared-card placement part 32B (hereinafter may be generically called “prepared-card placement part 32”), a win/loss condition card placement part 33A and a win/loss condition card placement part 33B (hereinafter may be generically called “win/loss condition card placement part 33”), a battle-card placement part 34A and a battle-card placement part 34B (hereinafter may be generically called “battle-card placement part 34”), and a consumed-card placement part 35A and a consumed-card placement part 35B (hereinafter may be generically called “consumed-card placement part 35”). The play mat 30 may be placed for each user. At this time, for example, the play mat 30 includes an area associated with one user. Specifically, for example, the play mat 30 includes the stock placement part 31A, the prepared-card placement part 32A, the win/loss condition card placement part 33A, the battle-card placement part 34A, and the consumed-card placement part 35A.

As shown in FIG. 3, in a TCG battle, users proceed with a battle between cards while replenishing hands with cards from stocks. In the example of FIG. 3, the user 5A has a hand 93A (two cards for the hand in the example of FIG. 3). The user 5B has a hand 93B (three cards for the hand in the example of FIG. 3).

The stock placement part 31 is an area for arranging some of the cards constituting the deck owned by each user. The stock placement part 31A is an area where the user 5A places cards as a stock. The stock placement part 31B is an area where the user 5B places cards as a stock.

As shown in FIG. 2, when each user starts a TCG battle, each user mixes cards constituting the deck and places the cards face down in the stock placement part 31. The user 5A places the cards as a stock 91A in the stock placement part 31A. The user 5B places the cards as a stock 91B in the stock placement part 31B.

The prepared-card placement part 32 is an area for preparing cards for a battle against the cards of the opponent. The users fight each other with cards placed in the battle-card placement part 34 while exchanging the cards placed in the prepared-card placement part 32 and the cards placed in the battle-card placement part 34.

As shown in FIG. 2, before the start of a TCG battle, no cards are placed in the prepared-card placement part 32 and the battle-card placement part 34. In contrast, as the TCG battle proceeds as shown in FIG. 3, the users place the cards in the prepared-card placement part 32 and the battle-card placement part 34 and fight each other with the cards in the battle-card placement part 34. The users place the cards to be used for the battle in the prepared-card placement part 32 and the battle-card placement part 34 from the hands while replenishing the hands with the cards from the stocks. The user 5A places the cards in the prepared-card placement part 32A. The user 5B places the cards in the prepared-card placement part 32B.

The win/loss condition card placement part 33 is an area indicating the level of satisfaction of win conditions by each player. In the present embodiment, with regard to the win/loss condition card placement part 33, each player places a predetermined number of cards face down in the win/loss condition card placement part 33 from the stock. As shown in FIG. 2, the user 5A places the cards in the win/loss condition card placement part 33A. The user 5B places the cards in the win/loss condition card placement part 33B.

The battle-card placement part 34 is an area for placing a card against a card of the opponent. The user 5A places the card in the battle-card placement part 34A. The user 5B places the card in the battle-card placement part 34B. In the present embodiment, basically, a card placed in the battle-card placement part 34A and a card placed in the battle-card placement part 34B fight against each other on the basis of a physical strength set for each card, an offensive strength, the attributes of a character shown on each card, the attributes of weak points, and other parameters. The card placed in the battle-card placement part 34 is damaged according to, for example, the offensive strength, the attributes of the card, and the weak points, and the physical strength is reduced according to the damage. When the physical strength set for the card is lost due to an attack or the like, the card is caused to retreat from the battle-card placement part 34 and is placed in the consumed-card placement part 35.

The consumed-card placement part 35 is an area for placing cards consumed in TCG battles. For example, cards that have lost physical strengths in battles and cards that have activated the effects are placed in the consumed-card placement part 35. As shown in FIG. 3, the user 5A places cards consumed in battles, as cards 92A in the consumed-card placement part 35A. The user 5B places cards consumed in battles, as cards 92B in the consumed-card placement part 35B.

### <0.2 Type of Card Used in TCG>

In a TCG of the present embodiment, types of cards include (i) a character card usable for a battle, (ii) an action power card (energy card) used in association with a character card, and (iii) an effect card (a support card, a goods card, a stadium card or the like) for activating a specific effect during a battle.
(i) Character cards include a card (also referred to as “unconditional card”) that can be placed in the prepared-card placement part 32 or the battle-card placement part 34 when being drawn from the stock and added to the hand by the user, and a card (also referred to as “conditional card”) that can be placed in the prepared-card placement part 32 or the battle-card placement part 34 when meeting a specific condition.
(iA) For example, a conditional card can be placed provided that an unconditional card associated with the conditional card is placed. For example, following the evolution of a character, an unconditional card is first presented to the other user by placing the unconditional card on the play mat 30, and then a conditional card associated with the unconditional card is placed on the play mat 30. Such conditional cards may also be referred to as “evolutionary characters” as cards evolved from unconditional cards. Unconditional cards may also be referred to as “seed characters” because the unconditional cards can also be regarded as original characters for placing “evolutionary characters”.
(iB) For example, a conditional card can be placed in the prepared-card placement part 32 or the battle-card placement part 34 by consuming a specific card and moving the card to the consumed-card placement part 35. Specifically, as a specific card, an unconditional card placed on the play mat 30 may be consumed (moved to the consumed-card placement part 35), and then the conditional card may be placed in the prepared-card placement part 32 or the battle-card placement part 34.

For example, a conditional card can be placed in the prepared-card placement part 32 or the battle-card placement part 34 in exchange with one or more character cards placed on the play mat 30 by the user. For example, when each character card is assigned with a parameter (e.g., an evolution level) indicating the overall performance of the character in addition to individual parameters such as the offensive strength of the character indicated on the card, a conditional card may be placed with an evolution level corresponding to the value of the evolution level of the character card placed by the user. For example, in a state in which a character with evolution level 1 and a character with evolution level 2 are placed on the play mat 30, a conditional card with evolution level 3 can be placed over the cards of these characters (or in exchange with these character cards).

In addition, the conditional card may be allowed to participate in a battle in exchange with a plurality of character cards determined by the conditional card. At this time, an auxiliary card, which is different from the character cards and will be described later, may be consumed to allow the conditional card to participate in the battle. For example, as an effect indicated on the auxiliary card, it is determined that a specific conditional card is allowed to participate in a battle in exchange with a specific unconditional card in, for example, the battle-card placement part 34 or the consumed-card placement part 35 on the play mat 30.
(iC) These cards also include cards serving as two or more of a character card, an action power card, which will be described later, and an auxiliary card. For example, a special card that can also be used as a character card and an auxiliary card may be included. The user can use the special card as a character card if the special card is placed at a position where the character card is to be placed (e.g., the prepared-card placement part 32 or the battle-card placement part 34).
(ii) An action power card (energy card) drawn from the stock and added to the hand by the user is placed in association with a character card on the play mat 30, enabling a predetermined action indicated on the character card. An operation for associating the action power card with the character card may be performed, for example, during the turn of the user. For example, the action power card may be associated with the character card by placing the action power card in the vicinity of the character card placed on the play mat 30. Furthermore, the number of times the action power card is associated with the character card may be limited during the turn. For example, once during the turn of the user, an action power card in the hand may be placed in association with one of character cards placed on the play mat 30. For example, it is assumed that a first attack action and a second attack action are set for a character card. The first attack action may be used when an action power card is associated with the character card, and the second attack action may be used when a single action power card is not sufficient and thus two action power cards are associated with the character card.

If the character card retreats from the battle-card placement part 34 due to exhaustion of the physical strength value by a battle or the like, the action power card associated with the character card may be disabled during the battle. Moreover, the action power card associated with the character card may be moved to the consumed-card placement part 35.
(iii) Auxiliary cards for assisting a battle include a type of card usable by any number by the user any number of times during a turn when being held in the hand of the user and a type of card usable alone during a turn. These auxiliary cards also include an auxiliary card that is made effective by declaring the use of the effect of the auxiliary card by the user.

The auxiliary cards further include an auxiliary card that is made effective by declaring the use of the auxiliary card with a voice or the like by the user in a state in which the auxiliary card is placed face down in advance at a predetermined position on the play mat 30.

### <0.3 Outline of TCG Battle Rules>

As described above, the play mat 30 used in a TCG battle and the card types have been described. The detail of the TCG battle rules will be described below.

In the TCG shown in the present embodiment, as described above, users proceed with a TCG battle by making an attack or defense (battle) on the basis of cards placed in the battle-card placement part 34A and the battle-card placement part 34B. It is assumed that the TCG battle proceeds when the users alternately act in each turn. For example, at the end of a turn after an action of the first user, the second user takes a turn. The second user acts in the turn, and at the completion of the action, the first user takes a turn.

Each user draws a predetermined number of cards from the stock and adds the cards to the hand in each turn.

From among the cards of the hand, each user places candidates for a card (character card) to be used for attack or defense of the user's card against an opponent in the prepared-card placement part 32.

The user 5A can exchange cards placed in the prepared-card placement part 32A and a card placed in the battle-card placement part 34A during the turn of the user 5A. Moreover, the user 5B can exchange cards placed in the prepared-card placement part 32A and a card placed in the battle-card placement part 34A during the turn of the user 5B.

As described above, the win/loss condition card placement part 33A and the win/loss condition card placement part 33B are areas for notifying each user about the progress of the battle under the conditions for each user to win a battle. In this case, the conditions for each user to win a battle may include, for example, the collection of all cards placed in the win/loss condition card placement part 33A or the win/loss condition card placement part 33B. In other words, the outcome of the battle may be determined when all the cards are collected from one of the win/loss condition card placement part 33A and the win/loss condition card placement part 33B.

For example, each user places a predetermined number of cards in the win/loss condition card placement part 33 prior to a TCG battle. In other words, the user 5A draws a predetermined number of cards from the stock 91A and places the cards in the win/loss condition card placement part 33A. The user 5B draws a predetermined number of cards from the stock 91B and places the cards in the win/loss condition card placement part 33B. The user 5A and the user 5B fight a battle with a character card placed in the battle-card placement part 34A and a character card placed in the battle-card placement part 34B. When the retreat conditions set for the character card are satisfied (for example, when the offensive strength set for the character card is subtracted to be exhausted on the basis of the offensive strength set for the character card of the opponent), the character card is moved to the consumed-card placement part 35 (also called “trash”) on the assumption that the character of the character card has fainted.

Thus, the user having won the battle and ejected the character card of the opponent adds the card placed in the win/loss condition card placement part 33A or the win/loss condition card placement part 33B to the hand. For example, when the user 5B attacks the character card of the user 5A in the turn of the user 5B to eject the card placed in the battle-card placement part 34A, the user 5B draws a predetermined number of cards from the cards placed in the win/loss condition card placement part 33B and adds the cards to the hand. On the other hand, when the user 5A attacks the character card of the user 5B in the turn of the user 5A to eject the card placed in the battle-card placement part 34B, the user 5A draws a predetermined number of cards from the cards placed in the win/loss condition card placement part 33A and adds the cards to the hand. These operations are repeated. When the user 5B collects all the cards placed in the win/loss condition card placement part 33B or the user 5A collects all the cards placed in the win/loss condition card placement part 33A, the user having collected the cards may be determined as the winning user of the TCG battle.

In addition, the win conditions of the battle may include a defeat in the absence of character cards in the battle-card placement part 34 and the prepared-card placement part 32. Furthermore, the win conditions of the battle may include a defeat when the user cannot draw cards from the stock placement part 31 in the turn of the user.

FIGS. 1 to 3 illustrate an example in which the users fight a TCG battle face-to-face. However, the TCG battle is not limited to a face-to-face battle between the users. The users to fight a battle may be connected via the Internet to acquire, for example, the voice of the opponent and the card layout of the opponent via the Internet. Specifically, for example, the users fight a battle while capturing images of the areas of the users on the play mat 30 with cameras or the like. The captured image is transmitted to the opponent in real time. The user receives an image of the area of the opponent from the opponent and displays the received image on the display. Thus, the user can confirm the cards of the opponent in real time through the screen while handling the real cards of the user. In this way, the users may fight an online TCG battle using analogue cards.

In the presence of a plurality of cameras or a device capable of adjusting the viewing angle of the camera, an image of the user's face may be captured and the captured image may be transmitted to the opponent. Thus, the facial expression of the opponent can be confirmed, so that the level of satisfaction in the online TCG battle can be ensured as in a face-to-face battle.

### <1 Configuration Diagram of Overall System>

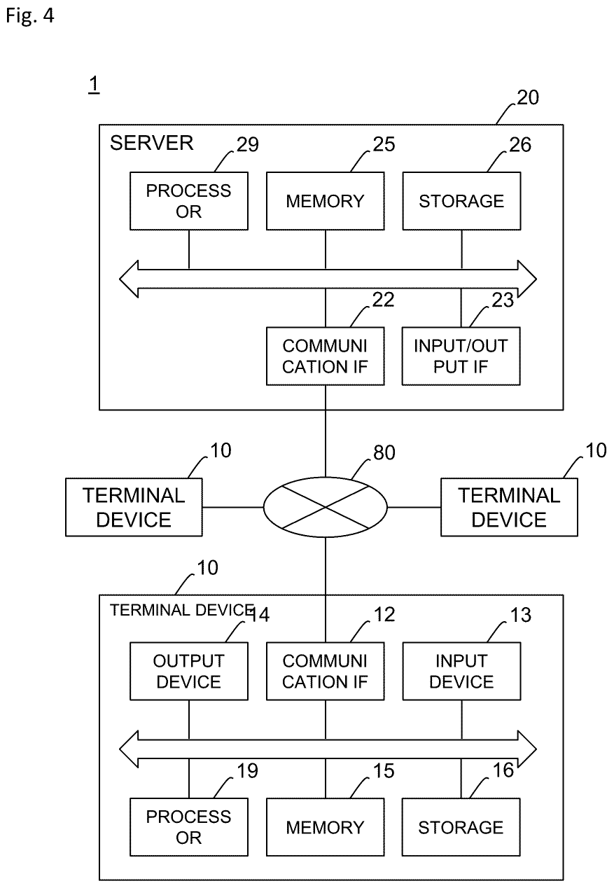

FIG. 4 is a block diagram illustrating an example of the overall configuration of a system 1. The system 1 illustrated in FIG. 4 includes, for example, terminal devices 10 and a server 20. For example, the terminal device 10 and the server 20 are communicatively connected via a network 80.

FIG. 4 shows an example in which the system 1 includes the three terminal devices 10. The number of terminal devices 10 included in the system 1 is not limited to three. The number of terminal devices 10 included in the system 1 may be two or less or four or more.

FIG. 4 shows an example in which the system 1 includes the single server 20. The number of servers 20 included in the system 1 is not limited to one. The server 20 may be composed of a plurality of servers depending on the functions of the server 20. Alternatively, the server 20 may be, for example, a single server configured as a set of multiple devices. A method for distributing multiple functions, which are required for implementing the server 20 according to the present embodiment, to one or more pieces of hardware can be determined as appropriate in consideration of, for example, the processing capability of each piece of hardware and/or specifications required for the server 20.

The terminal device 10 in FIG. 4 is, for example, an information processing device operated by a user playing a digital TCG. The terminal device 10 is implemented by, for example, a mobile terminal such as a smartphone or a tablet. The terminal device 10 may be implemented by a stationary PC (Personal Computer) or a laptop PC or may be implemented by a wearable terminal such as an HMD (Head Mount Display).

The terminal device 10 includes a communication IF (Interface) 12, an input device 13, an output device 14, a memory 15, a storage 16, and a processor 19. The input device 13 is a device (e.g., a touch panel or a touch pad) for receiving an input operation from the user. The output device 14 is a device (a display, a speaker or the like) for presenting information to the user.

The server 20 is, for example, an information processing device that manages card information and deck information.

The server 20 is implemented by, for example, a computer connected to the network 80. As shown in FIG. 4, the server 20 includes a communication IF 22, an input/output IF 23, a memory 25, a storage 26, and a processor 29. The input/output IF 23 functions as an interface between an input device for receiving an input operation from the user and an output device for presenting information to the user.

Each of the information processing devices is composed of a computer equipped with an arithmetic unit and a storage device. The basic hardware configuration of the computer and the basic functional configuration of the computer implemented by the hardware configuration will be described later. Regarding the terminal device 10 and the server 20, descriptions overlapping the basic hardware configuration of the computer and the basic functional configuration of the computer, which will be described later, will be omitted.

### <1.1 Configuration of Terminal Device>

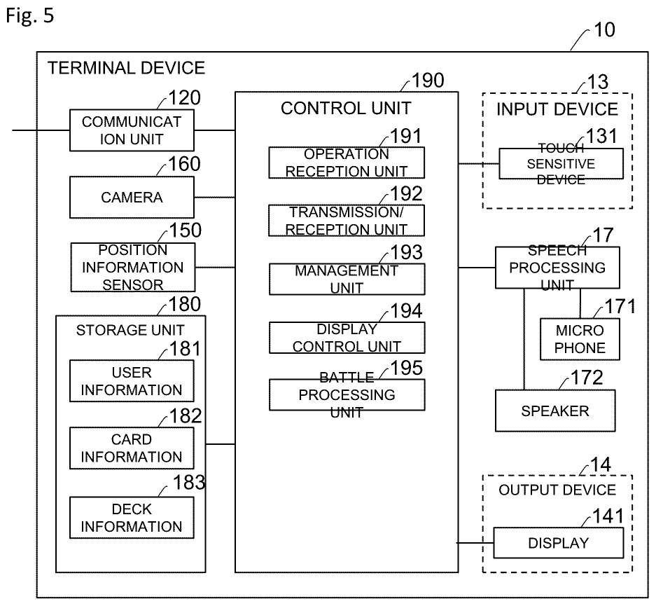

FIG. 5 is a block diagram of a configuration example of the terminal device 10 shown in FIG. 4. As illustrated in FIG. 5, the terminal device 10 includes a communication unit 120, the input device 13, the output device 14, a speech processing unit 17, a microphone 171, a speaker 172, a camera 160, a position information sensor 150, a storage unit 180, and a control unit 190. Blocks included in the terminal device 10 are electrically connected to one another via, for example, a bus.

The communication unit 120 performs processing such as modulation demodulation processing for the terminal device 10 communicating with another device. The communication unit 120 performs transmission processing on a signal generated by the control unit 190 and transmits the signal to the outside (for example, the server 20). The communication unit 120 performs reception processing on a signal received from the outside and outputs the signal to the control unit 190.

The input device 13 is a device that allows a user operating the terminal device 10 to input an instruction or information. The input device 13 is implemented by, for example, a touch sensitive device 131 to which an instruction is input by touching the operation surface. When the terminal devices 10 is a PC or the like, the input device 13 may be implemented by a reader, a keyboard, or a mouse or the like. The input device 13 converts an instruction input from the user into an electrical signal and outputs the electrical signal to the control unit 190. The input device 13 may include, for example, a reception port for receiving an electrical signal input from an external input device.

The output device 14 is a device for presenting information to the user operating the terminal device 10. The output device 14 is implemented by, for example, a display 141. The display 141 displays data under the control of the control unit 190. The display 141 is implemented by, for example, a liquid crystal display (LCD) or an organic electro-luminescence (EL) display.

For example, the speech processing unit 17 performs digital-to-analog conversion processing on an audio signal. The speech processing unit 17 converts a signal from the microphone 171 into a digital signal and supplies the converted signal to the control unit 190. Furthermore, the speech processing unit 17 provides the audio signal to the speaker 172. The speech processing unit 17 is implemented by, for example, a processor for speech processing. The microphone 171 receives a voice input and provides the speech processing unit 17 with an audio signal corresponding to the voice input. The speaker 172 converts the audio signal supplied from the speech processing unit 17 into a sound and outputs the sound to the outside of the terminal device 10.

The camera 160 is a device for receiving light through a light receiving element and outputting the light as a photographic signal.

The position information sensor 150 is a sensor that detects the position of the terminal device 10 and serves as, for example, a global positioning system (GPS) module. The GPS module is a receiving apparatus used in a satellite positioning system. The satellite positioning system receives signals from at least three or four satellites and detects the current position of the terminal device 10, which is equipped with the GPS module, on the basis of the received signals. The position information sensor 150 may detect the current position of the terminal device 10 from the position of a radio base station to which the terminal device 10 is connected.

The storage unit 180 is implemented by, for example, the memory 15 and the storage 16 or the like and stores data and programs that are used by the terminal device 10. For example, the storage unit 180 stores user information 181, card information 182, and deck information 183.

The user information 181 includes, for example, information about a user who plays a TCG. The information about the user includes, for example, a user ID and the name, the age, the address, the date of birth, and the date of registration of the user.

The card information 182 includes, for example, information about cards. The card information 182 may include information about cards owned by the user. The details will be described later.

The deck information 183 includes, for example, information about a deck constructed by the user. The details will be described later.

The control unit 190 is implemented by the processor 19 reading the program stored in the storage unit 180 and executing instructions included in the program. The control unit 190 controls an operation of the terminal device 10. The control unit 190 operates according to the program, thereby exhibiting the functions of an operation reception unit 191, a transmission/reception unit 192, a management unit 193, a display control unit 194, and a battle processing unit 195.

The operation reception unit 191 performs processing for receiving an instruction or information input from the input device 13. Specifically, for example, the operation reception unit 191 receives an instruction or information input from the touch sensitive device 131 or the like.

Furthermore, the operation reception unit 191 receives an image input from the camera 160. Specifically, for example, the operation reception unit 191 receives photographic data captured by the camera 160.

Moreover, the operation reception unit 191 receives speech information input from the microphone 171. Specifically, for example, the operation reception unit 191 receives voice data that is input from the microphone 171 and converted into digital data by the speech processing unit 17.

The transmission/reception unit 192 performs processing for the terminal device 10 transmitting or receiving data to or from an external device such as the server 20 according to a communication protocol. Specifically, for example, the transmission/reception unit 192 transmits an instruction input from the user or various types of acquired information to the server 20. The transmission/reception unit 192 also receives information provided from the server 20. The information provided from the server 20 includes, for example, information about a card additionally acquired by the user or information about a deck registered in the server 20.

The management unit 193 manages the user information 181, the card information 182, and the deck information 183 that are stored in the storage unit 180. For example, when information about the user is edited, the management unit 193 stores the edited information in the user information 181. The management unit 193 also updates the card information 182 when receiving information about the card. Specifically, the management unit 193 updates the card information 182, for example, when a battle is fought using cards. Furthermore, the management unit 193 updates the card information 182, for example, when support is provided via a card. Moreover, the management unit 193 updates the deck information 183 when decks are organized.

The display control unit 194 controls the output device 14 to display a predetermined image for the user. For example, on the basis of the information managed by the card information 182 and the information managed by the deck information 183, the display control unit 194 controls the display 141 so as to display a management screen for a card owned by the user. The display control unit 194 also controls the display 141 such that information about a battle using a card selected by the user is displayed in association with the card. Furthermore, the display control unit 194 controls the display 141 such that information about support provided via a card selected by the user is displayed in association with the card.

The battle processing unit 195 controls battle processing against another user. For example, battles are intended to represent the following types.
A battle against a CPU with a deck constructed with digital cards
A battle against another player with a deck constructed with digital cards
A battle in a tournament

### <1.2 Functional Configuration of Server>

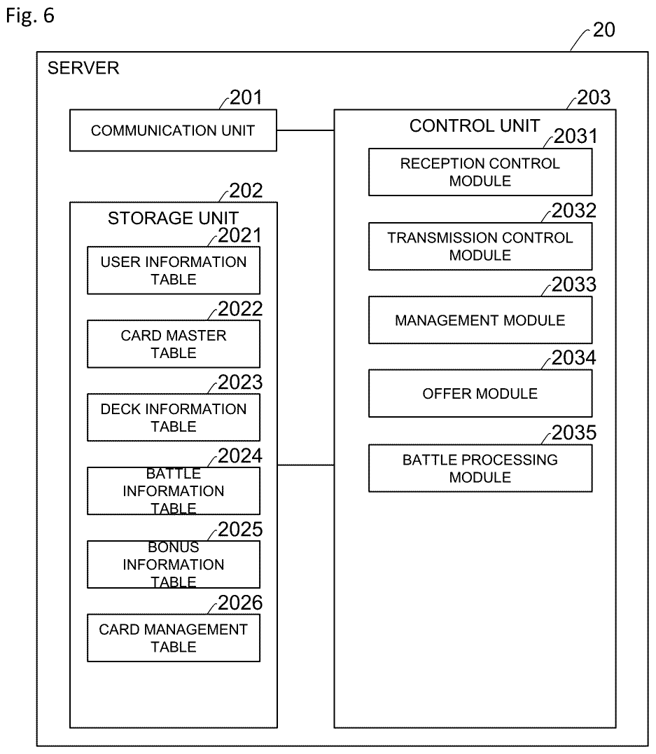

FIG. 6 shows an example of the functional configuration of the server 20. As illustrated in FIG. 6, the server 20 functions as a communication unit 201, a storage unit 202, and a control unit 203.

The communication unit 201 performs processing for the server 20 communicating with an external device.

The storage unit 202 includes, for example, a user information table 2021, a card master table 2022, a deck information table 2023, a battle information table 2024, a bonus information table 2025, and a card management table 2026.

The user information table 2021 is, for example, a table for storing information about users registered for TCG service. The details will be described later.

The card master table 2022 is, for example, a table for storing information about cards available for users. The details will be described later.

The deck information table 2023 is, for example, a table for storing information about a deck registered by the user. The details will be described later.

The battle information table 2024 is, for example, a table for storing information about battles fought in the past. The details will be described later.

The bonus information table 2025 is, for example, a table for storing information about bonuses (bonus information) to be offered to users. The details will be described later.

The card management table 2026 is, for example, a table for storing information for managing cards acquired by the user. The details will be described later.

The control unit 203 is implemented by the processor 29 reading the program stored in the storage unit 202 and executing instructions included in the program. The control unit 203 operates according to the program, thereby exhibiting the functions of a reception control module 2031, a transmission control module 2032, a management module 2033, an offer module 2034, and a battle processing module 2035.

The reception control module 2031 controls processing for the server 20 receiving a signal from an external device according to a communication protocol.

The transmission control module 2032 controls processing for the server 20 transmitting a signal to an external device according to a communication protocol.

The management module 2033 manages tables stored in the storage unit 202. Specifically, for example, the management module 2033 updates the deck information table 2023 in response to an input of an operation for a deck. The management module 2033 also updates the battle information table 2024 and the card management table 2026 when receiving information about battles. Furthermore, the management module 2033 updates the card management table 2026 when receiving information about support.

The offer module 2034 offers a bonus to the user. For example, the offer module 2034 refers to the bonus information table 2025 to offer a bonus to a user meeting the conditions.

The battle processing module 2035 controls battle processing between users. For example, the battle processing module 2035 controls a battle between players using decks constructed with digital cards.

### <2 Data Structure>

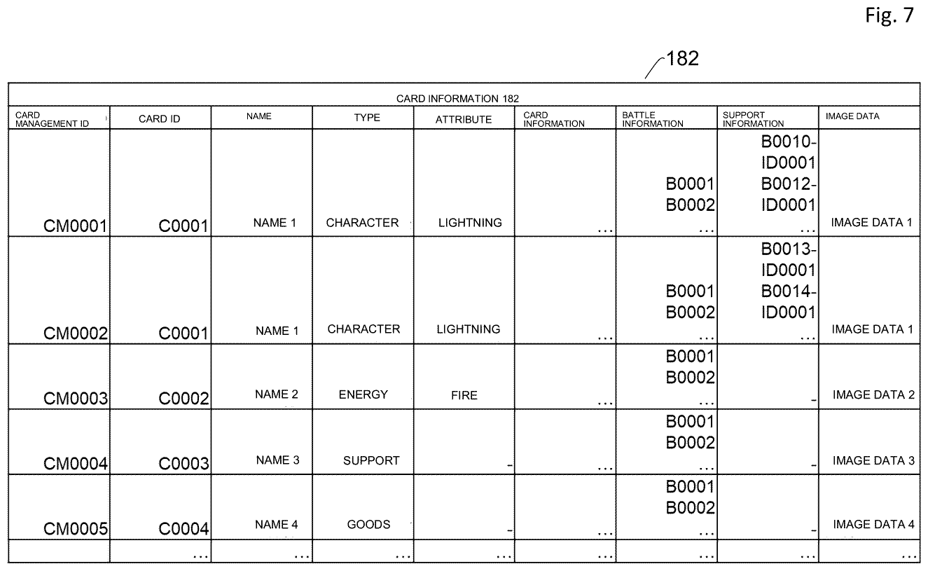

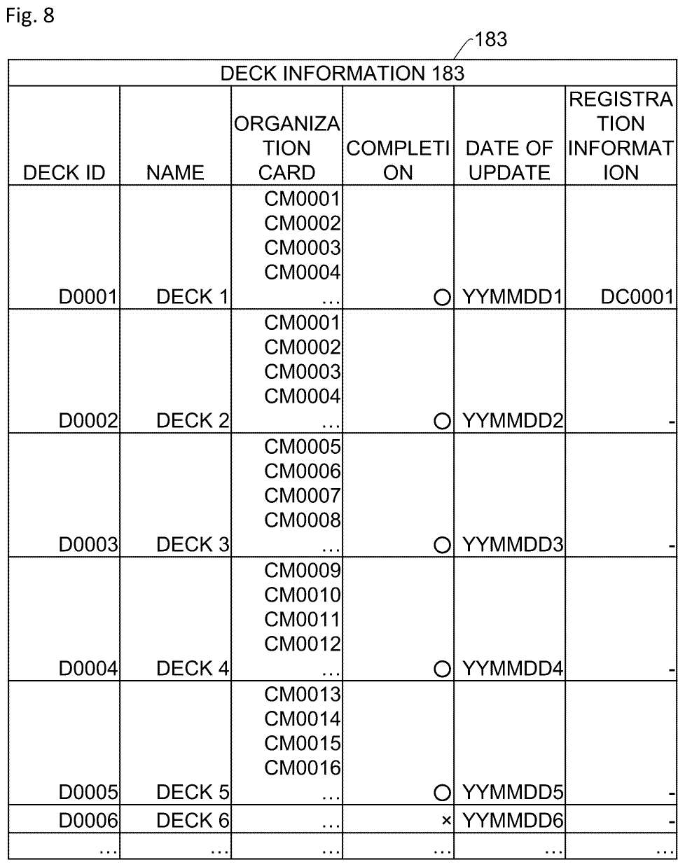

FIGS. 7 and 8 show the data structures of information stored in the terminal device 10. FIGS. 7 and 8 are merely exemplary and do not exclude data not shown in the drawings.

FIG. 7 shows the data structure of the card information 182. The card information 182 shown in FIG. 7 is a table including the columns of a card ID, a name, a type, an attribute, card information, battle information, support information, and image data with a card management ID serving as a key. The card information 182 may include regulations or information about rarity in addition to these items of information.

The card management ID is an item that stores an identifier for uniquely identifying the user. In the present embodiment, cards with the same name, the same effect, the same rarity, and the same regulations, that is, completely identical cards are assigned with different card management IDs. The card ID is an item that stores an identifier for uniquely identifying a card type. In the present embodiment, the same card ID is assigned to completely identical cards. The name is an item that stores a card name. The type is an item that stores a card type. In the present embodiment, the types of cards include, for example, a character, an energy, a support, goods, and a stadium.

The attribute is an item that stores a property to which a character belongs. In the present embodiment, attributes include, for example, fire, water, lightning, grass, super, steel, evil, and fight. Some attributes are advantageous and other attributes are disadvantageous in a battle. The card information is an item that stores information describing the contents of cards. When a card type is a character, the card information includes, for example, offensive strength, physical strength, energy required for techniques, energy required for escape, weak points, resistance, and special characteristics of characters. When card types are support, goods, and a stadium, the card information includes, for example, requirements for card use and effects obtained when a card is used.

The battle information is an item that stores information about a TCG battle fought with a deck including applicable cards. In the present embodiment, a battle ID that allows identification of a battle is stored as battle information. For example, the server 20 registers, as battle information, information that specifies a battle fought by the user using a deck including applicable cards. The item “battle information” is, for example, battle information that is registered in the server 20, is transmitted to the terminal device 10, and is stored therein.

The support information is an item that stores information about a TCG battle supported in association with applicable cards. In the present embodiment, a battle ID that allows identification of a supported battle is stored as support information. The server 20 manages, for example, support in association with the card management ID, the support being provided by the user in association with applicable cards. The item “support information” is support information that is managed by the server 20, is transmitted to the terminal device 10, and is stored therein.

Image data is an item that stores an image. The image data may store reference information (paths) for image data files placed at other locations.

FIG. 8 shows the data structure of the deck information 183. The deck information 183 in FIG. 8 is a table including the columns of a name, an organization card, completion, a date of update, and registration information with a deck ID serving as a key. The deck information 183 may include information about the common name of the deck and the usage history of the deck in addition to these items of information. The common name of the deck is, for example, a name that is assigned on the basis of characteristic cards used for the deck and is assigned with a common recognition among a plurality of users, the name directly representing the characteristics of the deck.

The deck ID is an item that stores an identifier for uniquely identifying a deck. The name is an item that stores the name of the deck. The name is, for example, assigned by the user. The organization card is an item that stores cards for organizing the deck. In the organization card, for example, the card management ID of a card for organizing the deck is stored.

Completion is an item that stores whether the deck has been completed or not. In the present embodiment, a circle indicates that the deck has been completed, whereas a cross indicates that the deck has not been completed. In the present embodiment, for example, the completion of the deck means that the deck including a predetermined number of cards is available for a battle. The date of update is an item that stores the date on which the configuration of the deck is changed. In the calculation of the date of update, as a change, cards used for one deck may be employed for another deck. The registration information is an item that stores a relationship with the deck registered in the server 20. The registration information stores, for example, a deck code issued when the deck is registered in the server 20.

A deck record is added when a new deck is created in the terminal device 10 in response to a user instruction.

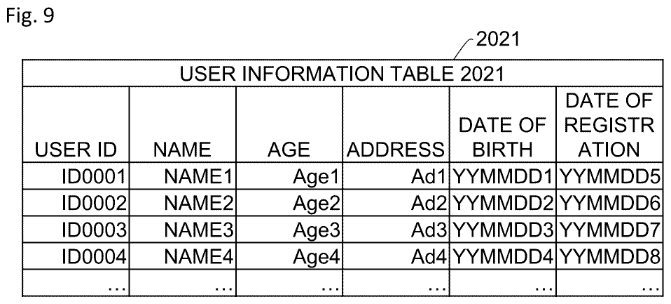

FIGS. 9 to 14 show the data structures of information stored in the server 20. FIGS. 9 to 14 are merely exemplary and do not exclude data not shown in the drawings.

FIG. 9 shows the data structure of the user information table 2021. The user information table 2021 in FIG. 9 is a table including the columns of a name, an age, an address, the date of birth, and the date of registration with a user ID serving as a key. The user information table 2021 may include a skill level as a column in addition to the above items.

The user ID is an item that stores an identifier for uniquely identifying the user. The user name is an item that stores the name of the user. The age is an item that stores the age of the user. The address is an item that stores the location where the user lives. The date of birth is an item that stores the date on which the user was born. The date of registration is an item that stores the date on which the user began to use the TCG service.

Records in the user information table 2021 are added when a user is newly registered.

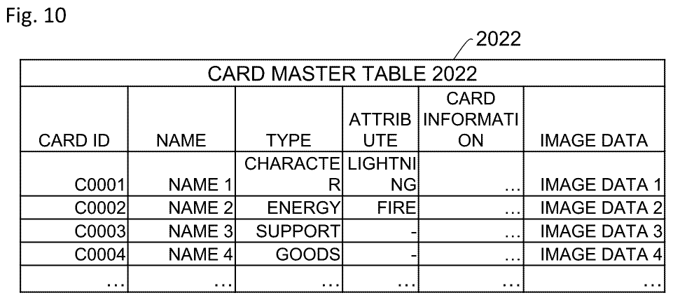

FIG. 10 shows the data structure of the card master table 2022. The card master table 2022 in FIG. 10 is a table including the columns of a name, a type, an attribute, card information, and image data with a card ID serving as a key.

The card ID is an item that stores an identifier for uniquely identifying a card type. The name is an item that stores a card name. The type is an item that stores a card type. The attribute is an item that stores a property to which a character belongs. The card information is an item that stores information describing the contents of cards. The image data is an item that stores an image.

Records in the card master table 2022 are added, for example, when a card is newly issued.

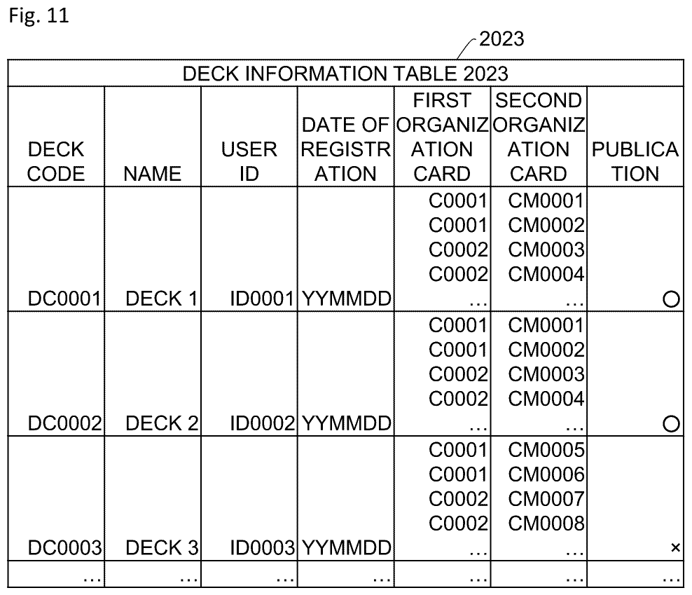

FIG. 11 shows the data structure of the deck information table 2023. The deck information table 2023 in FIG. 11 is a table including the columns of a name, a user ID, a registration date, a first organization card, a second organization card, and publication with a deck code serving as a key. The deck information table 2023 may include information about the common name of the deck in addition to these items of information.

The deck code is an item that stores an identifier for uniquely identifying a registered deck. A deck code is issued by the management module 2033 when a new deck is registered by the user. For example, the deck code in FIG. 11 has an identifier different from that of the deck ID shown in FIG. 8. This is because the deck code in FIG. 11 is set to manage a published deck while the deck ID in FIG. 8 is set to manage the deck of the user. The name is an item that stores the name of the deck. The name is assigned by the user. The user ID is an item that stores the user ID of the user having registered the deck. The registration date is an item that stores the date on which the deck was registered.

The first organization card and the second organization card are items that store cards to organize the deck. The first organization card stores, for example, the card ID of a card for organizing the deck. The second organization card stores, for example, the card management ID of a card for organizing the deck. The publication is an item that stores whether the deck has been published to other users. In the present embodiment, a circle indicates that the deck has been published to other users, whereas a cross indicates that the deck has not been published to other users. In the present embodiment, the unpublished deck means that only the user can confirm the deck.

Records in the deck information table 2023 are added when a deck is newly registered.

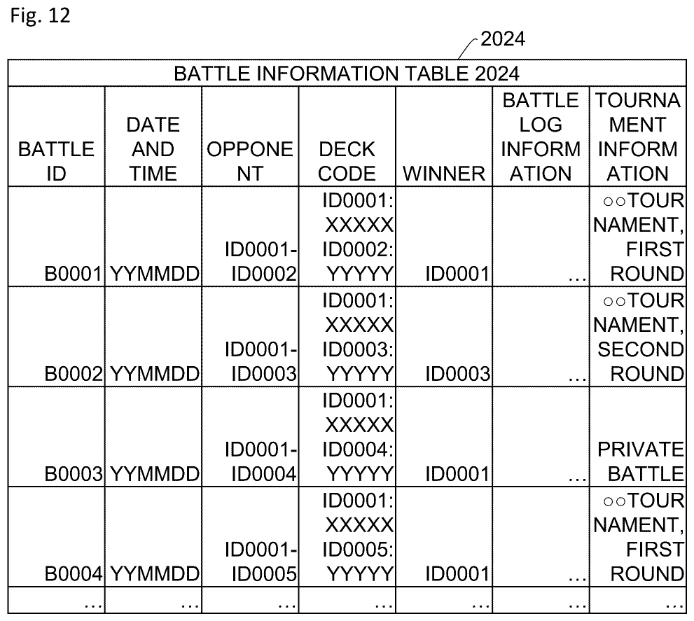

FIG. 12 shows the data structure of the battle information table 2024. The battle information table 2024 in FIG. 12 is a table including the columns of a date and time, an opponent, a deck code, a winner, battle log information, and tournament information with a battle ID serving as a key.

The battle ID is an item that stores an identifier for uniquely identifying the battle. The battle ID is issued by the management module 2033 when new information about a battle is registered. The date and time is an item that stores a date and time of a battle. The opponent is an item that stores information about a player having fought a battle. In the present embodiment, for example, the user IDs of players having fought a battle are stored in the opponent.

The deck code is an item that stores a code for identifying a deck used in a battle. In the present embodiment, for example, a player having fought a battle and the deck code of a deck used by the player are associated with each other. The deck code is not necessarily stored. In other words, the deck code may be unregistered.

The winner is an item that stores the winner of a battle. The battle log information is an item that stores techniques adopted by a player during a battle. Specifically, for example, the battle log information includes: drawing a card from a predetermined placement part (a stock or win/loss condition cards or the like) by the player; placing the card in the predetermined placement part by the player; and using the effect of a predetermined card by the player. A technique adopted by the player in a battle may also be referred to as a deck shuffle. The tournament information is an item that stores information about battles. For example, the tournament information includes the tournament name of a battle and the number of battle rounds in a tournament. The tournament information may include battle information about private tournaments as well as public tournaments. Furthermore, the tournament information is not limited to tournaments and may include battle information about private battles.

Records in the battle information table 2024 are added when a battle is newly registered.

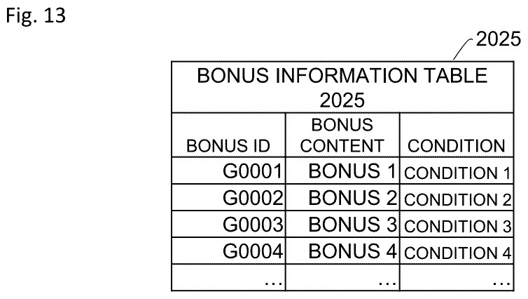

FIG. 13 shows the data structure of the bonus information table 2025. The bonus information table 2025 in FIG. 13 is a table including the columns of a bonus content and a condition with a bonus ID serving as a key.

The bonus ID is an item that stores an identifier for uniquely identifying a bonus. The bonus content is an item that stores the content of the bonus. The condition is an item that stores a condition where the bonus is offered.

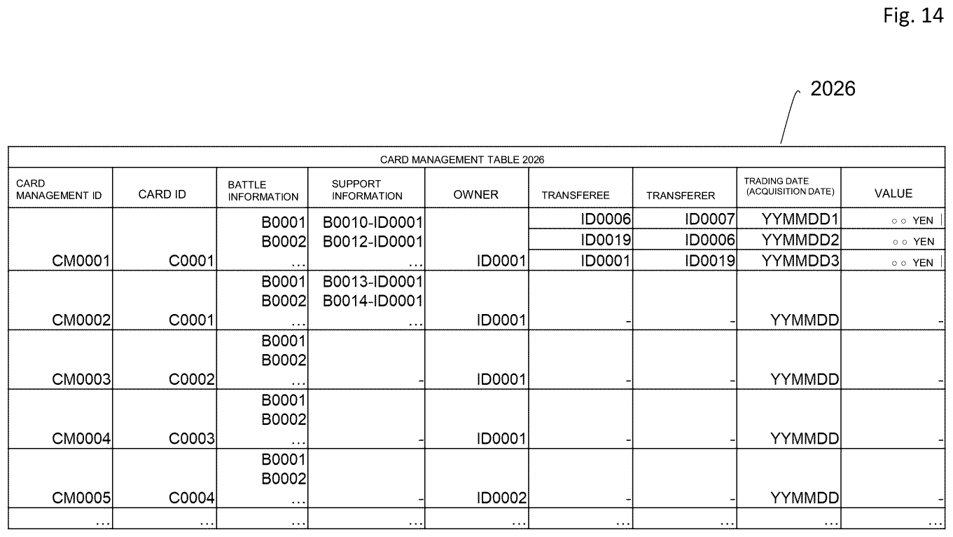

FIG. 14 shows the data structure of the card management table 2026. The card management table 2026 in FIG. 14 is a table including the columns of a card ID, battle information, support information, an owner, a transferee, a transferer, a trading date, and a value with a card management ID serving as a key.

The owner is an item that stores information about a user who owns a card. In the present embodiment, the user ID of the user who owns the card is stored in the owner.

The transferee, the transferer, the trading date, and the value are items that store information about the trading of the card identified by the card management ID. The transferee, the transferer, the transaction date, and the value are added for each trade. The transferee represents a person who has received a card in trading. The transferer represents a person who has transferred a card in trading. The trading date represents the date on which trade is conducted. The value represents the cost paid to the transferer from the transferee when trading a card.

### <3 Operation>

The operations of the terminal device 10 and the server 20 in the management of digital cards will be described below.

### (Updating of Card Management Table, Purchase of Card)

The server 20 sells, for example, a digital card. For example, the server 20 sells a card in a manner that allows the user to recognize the content of the card. Alternatively, the server 20 may sell a card in a manner that does not allow the user to recognize the content of the card. The server 20 sells one card for each sale. Alternatively, the server 20 may sell a plurality of cards for each sale.

The server 20 may also function as a platform where the user sells cards to other users. The server 20 publishes cards with user-specified sales conditions such as a price to other users such that the other users can purchase the cards. In agreement with sales conditions set by another user, the user selects and purchase the card.

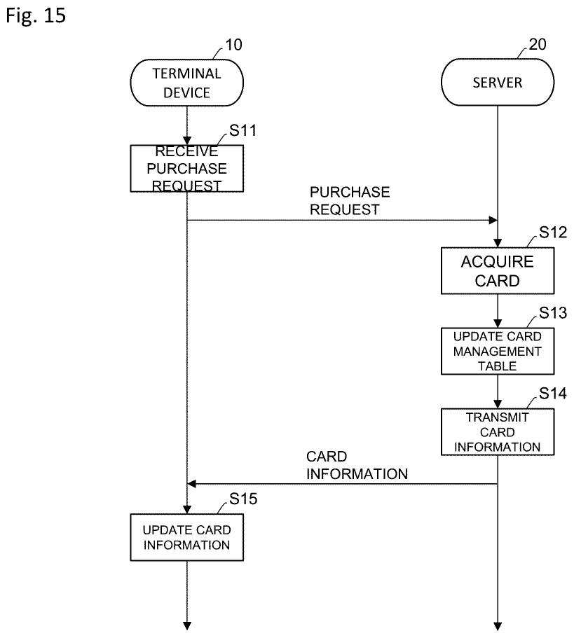

FIG. 15 is an explanatory drawing showing an operation example of the terminal device 10 and the server 20 when the user purchases a card.

When purchasing the card, the user accesses the server 20 by using the terminal device 10. The terminal device 10 acquires information about the card on sale in the server 20 and displays the information on the display 141. The user refers to cards displayed on the display 141 and selects any of desired cards. The user inputs a request to purchase the selected card to the terminal device 10.

In step S11, the terminal device 10 receives the card purchase request input from the user, through the operation reception unit 191. The terminal device 10 transmits the received purchase request to the server 20 through the transmission/reception unit 192.

In step S12, the server 20 obtains the card on the basis of the card purchase request from the user. Specifically, for example, the server 20 consumes information about a predetermined asset associated with the user through the management module 2033, so that the server 20 obtains the card selected by the user. For example, information about predetermined assets includes:
Game media for use in games
Crypto assets
Tokens
Information about currencies

When the user selects a card that is on sale in a manner that allows the user to recognize the card content, the management module 2033 acquires the card ID of the card selected by the user. When the user selects a card that is on sale in a manner that does not allow the user to recognize the card content, the management module 2033 holds a card lottery and acquires the card ID of the card selected by the lottery. When the user selects a card that is offered for sale by another user, the management module 2033 obtains the card management ID of the card selected by the user from the card management table 2026.

In step S13, the management module 2033 updates the card management table 2026 on the basis of the acquired card ID. Specifically, for example, when acquiring the card ID of a card that is on sale in a manner that allows the user to recognize the card content, and when acquiring the card ID of a card selected by lottery, the management module 2033 issues a card management ID for the corresponding card. The management module 2033 issues a record in which the card management ID serves as a key in the card management table 2026, and stores information in the card ID and the owner in the record.

Furthermore, for example, when acquiring the card management ID of a card that is offered for sale by another user, the management module 2033 changes the owner of the card in the card management table 2026. The management module 2033 may add a new owner instead of the rewriting the owner of the card in the card management table 2026. In addition, the management module 2033 stores information about the trading in a record in which the acquired card management ID serves as a key. Specifically, for example, the management module 2033 stores the transferee, the transferer, the trading date, and the value in a record in which the acquired card management ID serves as a key.

In step S14, the server 20 transmits information about the card purchased by the user to the terminal device 10. Specifically, for example, the management module 2033 reads information about the card purchased by the user, from the card master table 2022 on the basis of the card ID. The management module 2033 reads, for example, a name, a type, an attribute, card information, and image data as the information about the card from the card master table 2022. The transmission control module 2032 transmits the card ID, the read information, and the card management ID to the terminal device 10.

In step S15, the terminal device 10 receives the information transmitted from the server 20 and updates the card information 182 on the basis of the received information. Specifically, for example, in the terminal device 10, the management unit 193 creates a new record in the card information 182 and stores the card management ID, the card ID, the name, the type, the attribute, the card information, and the image data.

### (Updating of Card Management Table, Storage of Battle Information)

The control unit 203 of the server 20 manages information about cards used in a battle, for each card by means of the management module 2033.

The user constructs the deck by combining the cards managed by the card information 182. The management unit 193 manages information about the deck constructed by the user, by using the deck information 183.

Furthermore, the user registers the deck constructed by the user in the server 20. Specifically, the user accesses the server 20 by using the terminal device 10. The terminal device 10 displays the registration form of the deck on the display 141, the registration form being set in the server 20. The user uses the form displayed on the display 141 to select cards to construct the deck. The user inputs a request to register the deck constructed by the selected cards and the name of the deck into the terminal device 10. The user may set whether to publish the registered deck to other users.

When a request to register the deck is input from the user, the management module 2033 issues a new deck code and creates a record in which the issued deck code serves as a key in the deck information table 2023. The management module 2033 stores, for example, the name of the created record, a user ID, a registration date, the first organization card, the second organization card, and the publication on the basis of information input from the user.

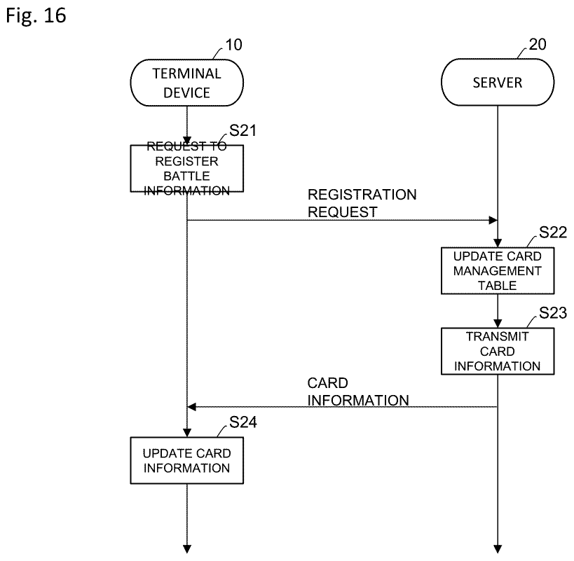

FIG. 16 is an explanatory drawing showing an operation example of the terminal device 10 and the server 20 when a card used by the user in a battle is managed.

At the start of a battle, the user accesses the server 20 by using the terminal device 10. The terminal device 10 displays the registration form of battle information on the display 141, the registration form being set by the server 20. The user inputs information about the battle by using the form displayed on the display 141. The information about the battle includes, for example, the date and time of the battle, an opponent, information about decks used in the battle, and tournament information. After inputting the information about the battle, the user inputs a request to register the battle information to the terminal device 10.

In step S21, the terminal device 10 receives the request input to register the battle information from the user, through the operation reception unit 191. The terminal device 10 transmits the input battle information and the registration request to the server 20 through the transmission/reception unit 192.

In step S22, the server 20 updates the card management table 2026 on the basis of the battle information input from the user. Specifically, for example, when receiving the request to register the battle information from the user, the management module 2033 issues a battle ID and creates a record in which the issued battle ID serves as a key in the battle information table 2024. The management module 2033 stores the date and time of the created record, an opponent, a deck code, and tournament information on the basis of information input from the user.

The date and time, the opponent, and the tournament information may be input in advance by a tournament organizer. In this case, the battle ID has already been issued, and the record has been created in the battle information table 2024. In addition, information about decks used in the battle may be pre-registered by the user. For example, multiple decks scheduled to be used in the tournament have been registered prior to the battle, and the user may select any one of the registered decks at the start of the battle.

When storing information in the battle information table 2024, the management module 2033 updates the card management table 2026. The management module 2033 stores information about the battle using the deck, for example, the battle ID in the item “battle information” of the corresponding record in the card management table 2026, on the basis of the card management ID of the card included in the deck. The amount of battle information to be stored increases with the number of battles. This can recognize which one of the battles has used the card.

In step S23, the server 20 transmits information managed in the card management table 2026 to the terminal device 10. Specifically, for example, when a new battle ID is stored in the item “battle information” of the card management table 2026, the management module 2033 reads the additionally stored battle ID, the card management ID, and the user ID as the owner. The transmission control module 2032 transmits the read battle ID and card management ID to the terminal device 10 owned by the user identified by the user ID.

In step S24, the terminal device 10 receives information transmitted from the server 20 and updates the card information 182 on the basis of the received information. Specifically, for example, in the terminal device 10, the management unit 193 stores the battle information received from the server 20, for example, the battle ID in the item “battle information” of the record identified by the card management ID.

At the start of a battle, in the control unit 203, the battle processing module 2035 controls battle processing between players. The battle processing module 2035 stores, in the storage unit 202, information about techniques adopted by the player during the battle. The management module 2033 stores the information about techniques adopted by the player during the battle, as battle log information in the battle information table 2024. At the end of the battle, the battle processing module 2035 recognizes the winning player in the battle as a winner. The management module 2033 stores the winner in the battle information table 2024.

### (Updating of Card Management Table, Storage of Support Information)

In the control unit 203 of the server 20, information about support for a deck associated with a card is managed for each card by the management module 2033.

The user may support a player who uses a deck in which cards are organized with emotional attachment. In the present embodiment, support for a deck associated with a card is managed in association with card information.

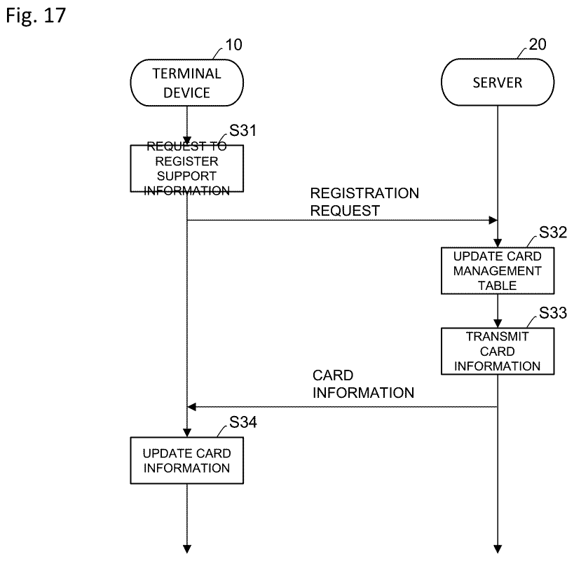

FIG. 17 is an explanatory drawing showing an operation example of the terminal device 10 and the server 20 when a card supported by the user is managed.

For example, it is assumed that information about tournament participants and decks used by the tournament participants is published before a tournament is held. The user refers to the tournament participants and the decks to select a player to be supported by the user. Before the tournament is held or before a predetermined time on the day of the tournament, the user accesses the server 20 by using the terminal device 10. The terminal device 10 displays the support form set in the server 20 on the display 141. The user selects a card as a basis of support by using the form displayed on the display 141 and inputs another player who uses the deck supported in association with the selected card. After inputting information about support, the user inputs a request to register the support information into the terminal device 10. The information about support includes, for example, the card management ID of the selected card and the user ID of the supported player. The user ID of the supported player may be a participant ID for participation in the tournament. The information about support may include, for example, information identifying the tournament or information identifying a battle in the tournament.

The card as a basis of support is, for example, a card having the same effect as a card constituting the supported deck. In this case, the card having the same effect refers to a card that provides the same effect in the progress of a TCG game when using cards during a play of the game. When the user is attached to a predetermined card, the user desires to support a player who uses a deck in which cards having the same effect as the predetermined card are organized. The user supports the player who uses the deck in which the cards are organized, on the basis of owned cards. Cards to be supported may have different rarities. When a card having the same effect as a card owned by the user is not included in the deck, support for a player who uses the deck may be prevented.

For example, only one player can be supported on the basis of a single card. Regardless of the number of cards, the number of players to be supported may be limited to one. Alternatively, only one player may be supported throughout the tournament or the player to be supported may be changed for each battle.

Furthermore, the target of support may be a deck instead of a player.

In the control unit 190, a card as a basis of support may be set by the management unit 193 such that the card as a basis of support cannot be used by the user in the deck during a period in which the user supports the deck. Thus, when supporting the deck, the user cannot use the selected deck, so that the user more seriously selects the deck to be supported.

In step S31, the terminal device 10 receives the request input to register support information from the user, through the operation reception unit 191. In the terminal device 10, the transmission/reception unit 192 transmits the input support information and the registration request to the server 20.

In step S32, the server 20 updates the card management table 2026 on the basis of the support information input from the user. Specifically, for example, the management module 2033 reads information about a battle from the battle information table 2024 when the request to register the support information is input from the user. The management module 2033 stores information based on battle information in the item “support information” of the corresponding record in the card management table 2026, on the basis of the card management ID included in the support information input from the user. The predetermined information to be stored in the item “support information” includes, for example, a battle ID and the user ID of a supported player. The amount of support information to be stored increases with the number of times of support. This can recognize that the support is based on the cards.

In step S33, the server 20 transmits information managed in the card management table 2026 to the terminal device 10. Specifically, for example, when a new battle ID and a new user ID are stored in the item “support information” of the card management table 2026, the management module 2033 reads the additionally stored battle ID and user ID, the card management ID, and the user ID as the owner. The transmission control module 2032 transmits the read battle ID, user ID, and card management ID to the terminal device 10 owned by the user identified by the user ID.

In step S34, the terminal device 10 receives information transmitted from the server 20 and updates the card information 182 on the basis of the received information. Specifically, for example, in the terminal device 10, the management unit 193 stores the support information received from the server 20, for example, the battle ID and the user ID in the item “support information” of the record identified by the card management ID.

At the start of a battle, in the control unit 203, the battle processing module 2035 controls battle processing between players. The battle processing module 2035 stores, in the storage unit 202, information about techniques adopted by the player during the battle. The management module 2033 stores the information about techniques adopted by the player during the battle, as battle log information in the battle information table 2024. At the end of the battle, the battle processing module 2035 recognizes the winning player in the battle as a winner. The management module 2033 stores the winner in the battle information table 2024. The management module 2033 may store information about win and loss in the item “support information” of the card management table 2026. The management module 2033 may store the result of a tournament in the battle information table 2024. For example, when a player has won in the final stage of the tournament, the winner may be stored in the battle information table 2024, and the fact that the player is the winner of the tournament may be stored as the result of the tournament in the battle information table 2024.

### (Bonus Offering Processing)

The offer module 2034 offers a bonus to the user who owns a card, on the basis of the history of use of the card and the history of support associated with the card.

Specifically, for example, the offer module 2034 determines whether information provided for the card satisfies conditions set in the bonus information table 2025. For example, the conditions related to the battle information are set in the bonus information table 2025 as follows:
Cards used in a predetermined tournament
Cards included in a deck that has reached a predetermined round of a predetermined tournament
Cards included in a deck that has obtained a predetermined record in a predetermined tournament
Cards used more than a predetermined number of times

For example, conditions related to the support information are set in the bonus information table 2025 as follows:
A supported player has reached a predetermined round in a predetermined tournament
A supported player has obtained a predetermined record in a predetermined tournament
The number of times of support has exceeded a predetermined number of times
The number of times of support for a single player has exceeded a predetermined number of times
The number of users supporting a player has exceeded a predetermined number of users

For example, other conditions are set in the bonus information table 2025 as follows:
A card after the lapse of a predetermined period of time since the card has been owned
A card owned by a predetermined number of users or more in the past

In the bonus information table 2025, a predetermined bonus content is set for each condition. For example, the bonus contents are set as follows:
Change of the appearance of a card
Provision of a card
Offering the right to create an original card
Provision of an original card created by a predetermined user (e.g., a winning supporter)
Offering the right to draw lots for cards
Advantageous effect in a tournament
Advantageous effect in drawing lots for cards

### (Display of Card Information)

The terminal device 10 displays a list of cards owned by the user, in response to an instruction from the user. The control unit 190 of the terminal device 10 displays a list of cards on the display 141 by the display control unit 194 on the basis of the card information 182 and the deck information 183.

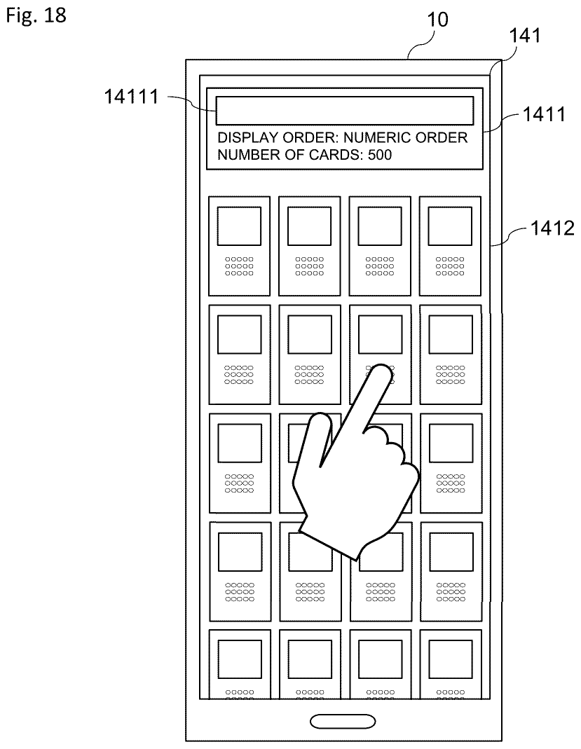

FIG. 18 is a schematic view showing a display example of the display 141 of the terminal device 10. In FIG. 18, the display control unit 194 displays an area 1411 and an area 1412. The area 1411 is an area that describes display conditions or the like. The area 1412 is an area in which cards owned by the user are displayed in a mode conforming to display conditions shown in the area 1411.

In the example shown in FIG. 18, the display order is displayed as a display condition in the area 1411. The display order represents the rule of order. The display order is selected by the user from, for example, the numeric order, the name order, the rarity order, and the acquisition date order. The display order can be switched, for example, from the numeric order to the name order, the rarity order, or the acquisition date order on the basis of an instruction from the user. In the example shown in FIG. 18, “Display order: numeric order” is selected, and cards are arranged in the order of arrangement of card IDs in the area 1412.

In the area 1411, a search window 14111 is displayed. When a card is desired, the user enters a keyword or the like in the search window 14111 to search for the desired card.

When the user selects a card displayed in the area 1412 in FIG. 18, the display control unit 194 displays detailed information on the selected card on the basis of the card information 182.

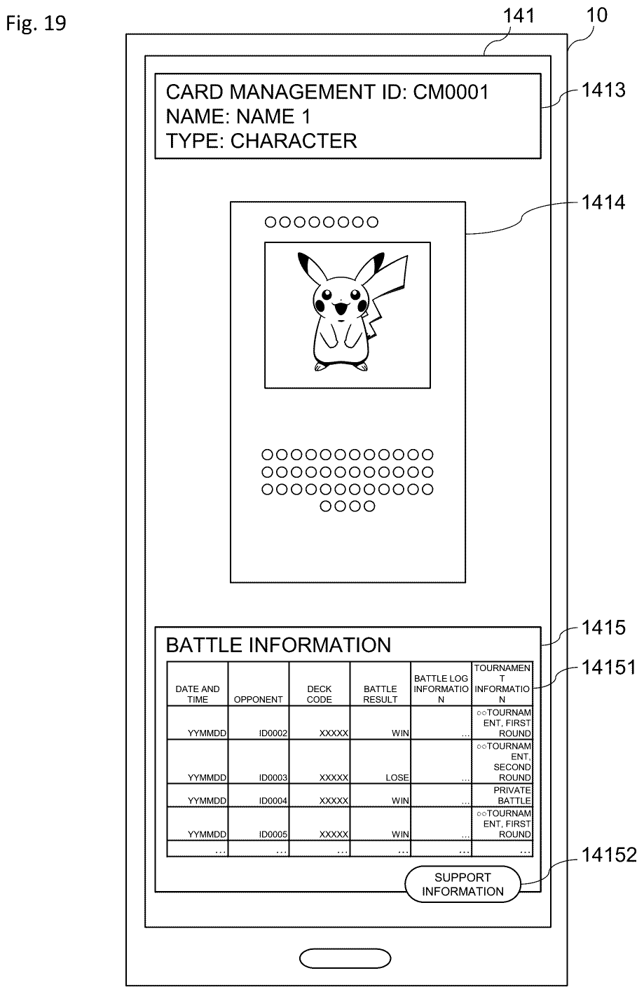

FIG. 19 is a schematic view showing a display example of the detailed information of a card displayed on the display 141. In FIG. 19, the display control unit 194 displays an area 1413, an area 1414, and an area 1415. The area 1413 is an area for describing, for example, information about the card. The area 1414 is an area for displaying the image of the card. The area 1415 is an area for describing battle information about the card.

The display control unit 194 displays information on the card in the area 1413 on the basis of information stored in the item “card management ID”, the item “name”, and the item “type” of the card information 182. The display control unit 194 displays an image in the area 1414 on the basis of information stored in the item “image data” of the card information 182.

The display control unit 194 reads information about the battle from the server 20 on the basis of information stored in the item “battle information” of the card information 182, and displays the read information in the area 1415. Specifically, for example, the display control unit 194 reads the battle ID stored in the item “battle information” of the card information 182 and requests information about the read battle ID from the server 20. The server 20 reads the information about the requested battle ID from the battle information table 2024 and transmits the read information to the terminal device 10. The display control unit 194 displays a list 14151 in the area 1415 on the basis of the information received from the server 20. The list 14151 displays information about battles in which the user has participated with decks including selected and organized cards.

In the area 1415, for example, a button 14152 for switching the display to support information is displayed. When the user depresses the button 14152, the display control unit 194 switches the display of the battle information to the display of support information.

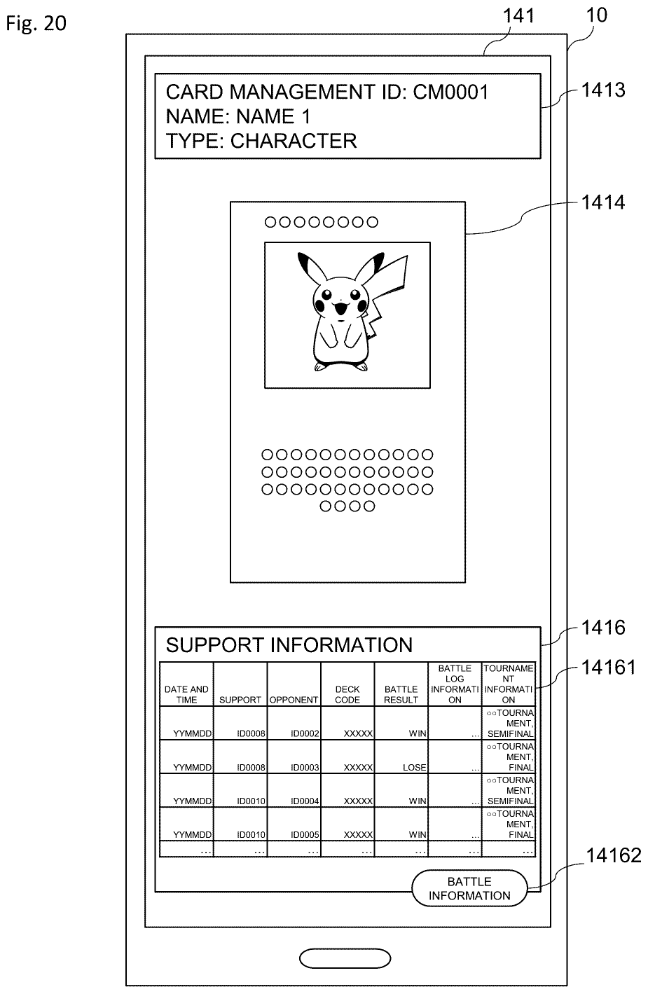

FIG. 20 is a schematic view showing another display example of the detailed information of the card displayed on the display 141. In FIG. 20, the display control unit 194 displays the area 1413, the area 1414, and an area 1416. The area 1416 is an area for describing support information based on the card.

The display control unit 194 reads information about the battle from the server 20 on the basis of information stored in the item “support information” of the card information 182, and displays the read information in the area 1416. Specifically, for example, the display control unit 194 reads the battle ID stored in the item “support information” of the card information 182 and requests information about the read battle ID from the server 20. The server 20 reads the information about the requested battle ID from the battle information table 2024 and transmits the read information to the terminal device 10. The display control unit 194 displays a list 14161 in the area 1416 on the basis of the information received from the server 20. The list 14161 displays information about the battles of supported players on the basis of the selected card.

In the area 1416, for example, a button 14162 for switching display to battle information is displayed. When the user depresses the button 14162, the display control unit 194 switches the display of the support information to the display of battle information.

The display control unit 194 may display information about card trading. Specifically, for example, the display control unit 194 reads the card management ID from the card information 182 and requests, from the server 20, information about the trading of a card identified by the read card management ID. The server 20 reads the requested information from the battle information table 2024 and transmits the read information to the terminal device 10. The display control unit 194 displays, for example, a list of the information about the trading of the card on the display 141 on the basis of the information received from the server 20.

As described above, in the foregoing embodiment, the control unit 203 of the server 20 stores information about a plurality of digital cards by means of the management module 2033. The management module 2033 stores information about card use, in which any one of the plurality of digital cards is used, in association with the used digital card. When receiving the selection of any one of the plurality of digital cards, the transmission control module 2032 transmits information about card use associated with the card to the terminal device 10 and presents the information to the user. Thus, the frequency of use of digital cards owned by the user is left as information for each of the owned digital cards.

Hence, according to the present embodiment, an attachment to the card can be left in a digital TCG.

Also, in the foregoing embodiment, the information about card use is information about a battle fought with a deck constructed by combining cards. Thus, the number of battles fought using digital cards owned by the user is left as information for each of the owned digital cards.

Furthermore, in the foregoing embodiment, information about a battle includes the date of the battle, the result of the battle, the opponent of the battle, information about a deck shuffle during the battle, information about the deck, or information about a tournament. Thus, the user can always review the details of the battle fought with the deck including the cards.

Moreover, in the foregoing embodiment, information about card use is information about support for another user who uses a deck constructed using a digital card having the same effect as the digital card owned by the user. Thus, the frequency of support using digital cards owned by the user is left as information for each of the owned digital cards.

Furthermore, in the foregoing embodiment, information about support includes another user using a deck, the result of a battle, the opponent of the battle, information about the deck, information about a tournament, or the result of the tournament. Thus, the user can always review the details of the battle fought with the deck supported in association with the cards.

Moreover, in the foregoing embodiment, the management module 2033 manages cards such that even the same digital cards can be uniquely identified. Hence, digital cards of the same type are not handled as a single digital card but can be handled uniquely like analog cards, strengthening an attachment of the user to the digital cards.

Furthermore, in the foregoing embodiment, the management module 2033 stores information about the trading of a digital card in association with the traded digital card. Thus, the user can also keep track of the transition of digital card ownership. Information about past owners also serves as an element forming an attachment to a card.

In addition, in the foregoing embodiment, information about trading includes the date and time of transfer, a user as a transferer, a user as a transferee, or the value of transfer. Thus, the user can always review the details of card trading.

Furthermore, in the foregoing embodiment, the offer module 2034 offers a bonus corresponding to information about use. Thus, the user can acquire a bonus according to the track record of card use. This leads to a motivation to use cards for a long time.

Moreover, in the foregoing embodiment, the offer module 2034 offers a bonus corresponding to information about a battle. Thus, the user can acquire a bonus according to the track record of battles using cards. This leads to a motivation to use a deck including the cards for a long time.

Furthermore, in the foregoing embodiment, the offer module 2034 offers a bonus corresponding to information about support. Thus, the user can acquire a bonus according to the track record of support based on cards. This leads to a motivation to use a deck including the cards for a long time.

### Modification Examples

In the foregoing embodiment, the user information table 2021, the card master table 2022, the deck information table 2023, the battle information table 2024, the bonus information table 2025, and the card management table 2026 are stored in the server 20. However, the information stored in these tables may not be stored in the server 20. For example, at least card information stored in the card management table 2026 may be stored in a blockchain (distributed ledger) formed by a peer-to-peer computer network.

At this time, each digital card is traded as a non-fungible token (NFT) in a blockchain. The card management ID in the foregoing embodiment corresponds to, for example, a unique identifier (NFT-ID) for identifying the NFT.

Trading of the NFT is performed by, for example, a smart contract implemented in a blockchain. The trading history for the NFT is stored as a transaction in the blockchain. Thus, the history of NFT owners is stored in the blockchain.

In addition, management for the use of the NFT is performed by, for example, a smart contract implemented in the blockchain. The usage history of the NFT is stored as a transaction in the blockchain. Thus, the usage history of the NFT in battles and the history of support for another player on the basis of the NFT are stored in the blockchain.

Furthermore, a bonus related to the usage history of the NFT is offered by, for example, a smart contract implemented in the blockchain. Thus, when the usage history of the NFT in battles meets a predetermined requirement, a predetermined bonus is offered to the NFT owner at that time. In addition, when the history of support for another player on the basis of the NFT meets a predetermined requirement, a predetermined bonus is offered to the NFT owner at that time.

In this way, the control unit 203 of the server 20 stores information about a plurality of digital cards in a distributed ledger, which is formed by a computer network, by means of the management module 2033. Alternatively, the control unit 190 of the terminal device 10 may store information about a plurality of digital cards in a distributed ledger, which is formed by a computer network, by means of the management unit 193. Thus, a digital card can be handled as an NFT. Moreover, clear records of digital cards can be kept.

The management module 2033 also stores information about card use as a transaction of the corresponding digital card in the distributed ledger. Note that the management unit 193 may store the information about card use as a transaction of the corresponding digital card in the distributed ledger. This can keep clear records of the usage history of the digital card.

Furthermore, the management module 2033 or the management unit 193 stores information about a battle as a transaction of the corresponding digital card in the distributed ledger. This can keep clear records of information about the battle of the digital card.

In addition, the management module 2033 or the management unit 193 stores information about support as a transaction of the corresponding digital card in the distributed ledger. This can keep clear records of information about support based on the digital card.

Furthermore, the management module 2033 or the management unit 193 stores information about trading as a transaction of the traded digital card. This can keep clear records of the trading of the digital card.

In the foregoing embodiment, the server 20 stores the battle information table 2024. Battle information about the user may be stored in the storage unit 180 of the terminal device 10. The management unit 193 may update battle information in the card information 182 on the basis of the battle information stored in the storage unit 180. When the card information 182 is updated, the transmission/reception unit 192 transmits information about the card to the server 20. The management module 2033 of the server 20 updates the battle information table 2024 on the basis of information transmitted from the terminal device 10. Thus, the terminal device 10 can recognize the battle information.

In the foregoing embodiment, a battle with the deck including organized cards and support based on a card were described as examples of card use. However, the card use is not limited thereto. For example, the card use may include the exhibition of cards.

In addition, the user may rent a card, for example. Specifically, for example, the user may transfer the right to use a card owned by the user to a player who uses a deck in which cards are organized with emotional attachment. Specifically, a card owned by the player to be supported may be replaced with a card of the user.

For example, it is assumed that information about tournament participants and decks used by the tournament participants is published before a tournament is held. The user refers to the tournament participants and the decks to select a player to be supported by the user. Before the tournament is held or before a predetermined time on the day of the tournament, the user accesses the server 20 by using the terminal device 10. The terminal device 10 displays, on the display 141, a rental application form set by the server 20. The user selects, by using the form displayed on the display 141, a card to be rented and inputs another player who intends to rent the card in association with the selected card. After inputting information about the rental, the user inputs a request to register the rental information into the terminal device 10. The information about the rental includes, for example, the card management ID of the selected card and the user ID of the player who intends to rent the card. The user ID of the player who intends to rent the card may be a participant ID for participation in the tournament. The information about the rental may include, for example, information that identifies a tournament or information that identifies a battle in the tournament.

The terminal device 10 receives the request input to register the rental information from the user, through the operation reception unit 191. The terminal device 10 transmits the input rental information and the registration request to the server 20 through the transmission/reception unit 192.

The server 20 updates the card management table 2026 on the basis of the rental information input from the user. Specifically, for example, the management module 2033 determines whether to rent the card to the player when a request to register the rental information is input from the user. The management module 2033 receives, for example, an application for rental from the user who meets a predetermined requirement. Alternatively, for example, the management module 2033 receives an application for rental at random. The management module 2033 reads information about a battle from the battle information table 2024. The management module 2033 stores information based on the information about the battle in an item “rental information” of the corresponding record in the card management table 2026 on the basis of the card management ID included in the rental information input from the user. The predetermined information stored in the item “rental information” includes, for example, a battle ID and the user ID of a supported player. The amount of information stored in the rental information increases with the number of times of rental. Thus, in a predetermined battle, the fact that the card has been rented and used can be recognized. Since the fact that the card has been used in the predetermined battle is stored, the user as the owner of the card can strengthen an attachment to the card.

The server 20 transmits information managed in the card management table 2026 to the terminal device 10. Specifically, for example, when a new battle ID and a new user ID are stored in the item “rental information” of the card management table 2026, the management module 2033 reads the additionally stored battle ID and user ID, the card management ID, and the user ID as the owner. The transmission control module 2032 transmits the read battle ID, user ID, and card management ID to the terminal device 10 owned by the user identified by the user ID.

The terminal device 10 receives the information transmitted from the server 20, and updates the card information 182 on the basis of the received information. Specifically, for example, in the terminal device 10, the management unit 193 stores the rental information received from the server 20, for example, the battle ID and the user ID in the item “rental information” of the record identified by the card management ID.

At the start of a battle, in the control unit 203, the battle processing module 2035 controls battle processing between players. The battle processing module 2035 stores, in the storage unit 202, information about techniques adopted by the player during the battle. The management module 2033 stores the information about techniques adopted by the player during the battle, as battle log information in the battle information table 2024. This will keep a record of under what circumstances the card rented from the user was used in a battle. At the end of the battle, the battle processing module 2035 recognizes the winning player in the battle as a winner. The management module 2033 stores the winner in the battle information table 2024. The management module 2033 may store information about win and loss in the item “rental information” of the card management table 2026. The management module 2033 may store the result of a tournament in the battle information table 2024. For example, when a player has won in the final stage of the tournament, the winner may be stored in the battle information table 2024, and the fact that the player is the winner of the tournament may be stored as the result of the tournament in the battle information table 2024.

### <4 Basic Hardware Configuration of Computer>

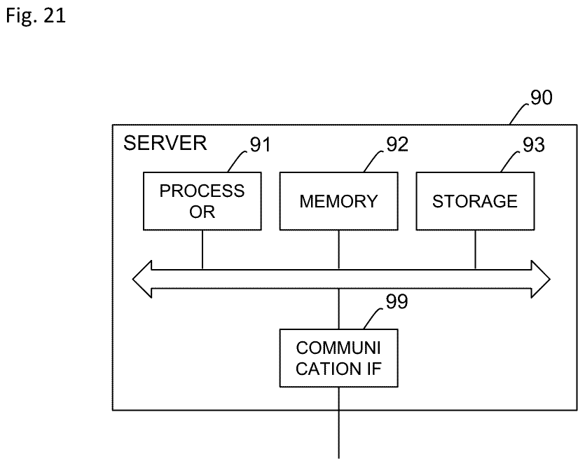

FIG. 21 is a block diagram illustrating a basic hardware configuration of a computer 90. The computer 90 includes at least a processor 91, a main storage device 92, an auxiliary storage device 93, and a communication IF 99 (Interface). These components are electrically connected to one another via a communication bus.

The processor 91 is hardware for executing a command set described in a program. The processor 91 includes an arithmetic device, a register, and a peripheral circuit.

The main storage device 92 is adapted to temporarily store a program and data processed by the program or the like. For example, the main storage device 92 is a volatile memory such as a dynamic random access memory (DRAM).

The auxiliary storage device 93 is a storage device adapted to save data and programs. For example, the auxiliary storage device is a flash memory, a hard disc drive (HDD), a magneto-optical disk, a CD-ROM, a DVD-ROM, or a semiconductor memory.

The communication IF 99 is an interface adapted to input and output signals to communicate with other computers via a network using a wired or wireless communication standard.

The network is configured with various mobile communication systems constructed by the Internet, a LAN, and a wireless base station or the like. For example, the network includes 3G, 4G, and 5G mobile communication systems, Long Term Evolution (LTE), a wireless network (e.g., Wi-Fi (registered trademark)) that can be connected to the Internet by a predetermined access point. In the case of wireless connection, communication protocols include, for example, Z-Wave (registered trademark), ZigBee (registered trademark), and Bluetooth (registered trademark). In the case of wired connection, the network includes a network directly connected via a universal serial bus (USB) cable.

Note that the computer 90 can be virtually implemented by providing all or some of hardware configurations in a distributed manner in the plurality of computers 90 and connecting the computers 90 via a network. In this manner, the computer 90 is a concept that includes not only the computer 90 accommodated in a single casing or case but also a virtualized computer system.

### <Basic Functional Configuration of Computer 90>

The functional configuration of a computer implemented by the basic hardware configuration of the computer 90 in FIG. 21 will be described below. The computer includes at least the functional units of a control unit, a storage unit, and a communication unit.

Note that the functional units included in the computer 90 can also be implemented by providing all or some of the functional units in a distributed manner in the plurality of computers 90 connected to one another via a network. The computer 90 is a concept that includes not only the single computer 90 but also a virtualized computer system.

The control unit is implemented by the processor 91 reading various programs stored in the auxiliary storage device 93, deploying the programs on the main storage device 92, and executing processing in accordance with the programs. The control unit can implement functional units that perform various kinds of information processing in accordance with the types of the programs. In this manner, the computer is implemented as an information processing device that performs information processing.

The storage unit is implemented by the main storage device 92 and the auxiliary storage device 93. The storage unit stores data, various programs, and various databases. Also, the processor 91 can secure a storage region corresponding to the storage unit in the main storage device 92 or the auxiliary storage device 93 in accordance with the programs. In addition, the control unit can cause the processor 91 to execute addition, update, and deletion processing of data stored in the storage unit in accordance with the various programs.

A database refers to a relational database and is adapted to manage data sets in a mutually associated manner, the data set being referred to as a tabular table structurally defined by rows and columns. In a database, a chart is called a table, a chart column is called a column, and a chart row is called a record. In a relational database, the relationship between tables can be set and the tables can be associated with each other.

Although a column as a key for uniquely specifying a record is typically set in each table, the setting of the key for the column is not always necessary. The control unit can cause the processor 91 to execute addition, deletion, and update of a record in a specific table, which is stored in the storage unit, in accordance with the various programs.

The communication unit is implemented by the communication IF 99. The communication unit implements the function of communicating with other computers 90 via a network. The communication unit can receive information transmitted from other computers 90 and input the information to the control unit. The control unit can cause the processor 91 to execute information processing on the received information in accordance with the various programs. Also, the communication unit can transmit information output from the control unit to other computers 90.

Although several embodiments of the present disclosure have been described above, these embodiments can be implemented in various other forms, and various omissions, replacements, and changes can be performed without departing from the spirit of the disclosure.

### APPENDICES

Matters described in each of the above embodiments will be appended below.

### Appendix 1

A program to be executed by a computer including a processor and a memory, the program causing the processor to perform the steps of: storing information about a plurality of digital cards such that even identical digital cards are uniquely identifiable; storing information about card use, in which any one of the digital cards is used, in association with the used digital card; and presenting, when receiving selection of any one of the digital cards, the information about the card use that is associated with the card.

### Appendix 2

The program according to (appendix 1), wherein in the step of storing the information about the card use, the information about the card use is information about a battle fought using a deck constructed by combining the cards.

### Appendix 3

The program according to (appendix 2), wherein the information about the battle includes the date of the battle, the result of the battle, the opponent of the battle, information about a deck shuffle during the battle, information about the deck, or information about a tournament.

### Appendix 4

The program according to (appendix 1), wherein in the step of storing the information about the card use, the information about the card use is information about support for another user who uses a deck constructed using a digital card having the same effect as the digital card owned by the user.

### Appendix 5

The program according to (appendix 4), wherein the information about the support includes another user using the deck, the result of a battle, the opponent of the battle, information about the deck, information about a tournament, or the result of the tournament.

### Appendix 6

The program according to any one of (appendix 1) to (appendix 5), wherein in the step of storing information about the digital card, information about the plurality of digital cards is stored in a distributed ledger formed by a computer network.

### Appendix 7

The program according to (appendix 6), wherein in the step of storing the information about the card use, the information about the card use is stored as a transaction of the corresponding digital card in the distributed ledger.

### Appendix 8

The program according to (appendix 6), wherein in the step of storing the information about the card use, the information about the card use is information about a battle fought using a deck constructed by combining the cards, and the information about the battle is stored as a transaction of the corresponding digital card in the distributed ledger.

### Appendix 9

The program according to (appendix 6), wherein in the step of storing the information about the card use, the information about the card use is information about support for another user who uses a deck constructed using a digital card having the same effect as the digital card owned by the user, and the information about the support is stored as a transaction of the corresponding digital card in the distributed ledger.

### Appendix 10

The program according to any one of (appendix 1) to (appendix 9), wherein the program causes the processor to perform the step of storing information about the trading of a digital card in association with the traded digital card.

### Appendix 11

The program according to (appendix 10), wherein in the step of storing the information about the trading, the information about the trading includes the date and time of transfer, a user as a transferer, a user as a transferee, or the value of transfer.

### Appendix 12

The program according to (appendix 10), wherein in the step of storing the information about the trading, the information about the trading is stored as a transaction of the traded digital card in the distributed ledger.

### Appendix 13

The program according to any one of (appendix 1) to (appendix 12), wherein the program causes the processor to perform the step of offering a bonus corresponding to information about use.

### Appendix 14

The program according to (appendix 13), wherein in the step of storing the information about the card use, the information about the card use is information about a battle fought using a deck constructed by combining the cards, and in the step of offering the bonus, a bonus corresponding to the information about the battle is offered.

### Appendix 15

The program according to (appendix 13), wherein in the step of storing the information about the card use, the information about the card use is information about support for another user who uses a deck constructed using a digital card having the same effect as the digital card owned by the user, and in the step of offering the bonus, a bonus corresponding to the information about the support is offered.

### Appendix 16

A method to be executed by a computer including a processor and a memory, the method performing the steps of: storing information about a plurality of digital cards such that even identical digital cards are uniquely identifiable; storing information about card use, in which any one of the digital cards is used, in association with the used digital card; and presenting, when receiving selection of any one of the digital cards, the information about the card use that is associated with the card.

### Appendix 17

An information processing device including a control unit and a storage unit, the control unit performing the steps of: storing information about a plurality of digital cards such that even identical digital cards are uniquely identifiable; storing information about card use, in which any one of the digital cards is used, in association with the used digital card; and presenting, when receiving selection of any one of the digital cards, the information about the card use that is associated with the card.

### Appendix 18

A system including: means for storing information about a plurality of digital cards such that even identical digital cards are uniquely identifiable; means for storing information about card use, in which any one of the digital cards is used, in association with the used digital card; and means for presenting, when receiving selection of any one of the digital cards, the information about the card use that is associated with the card.

1. A non-transitory computer-readable storage medium storing computer-readable instructions for a program to be executed by a computer including a processor and a memory, the program causing the processor to perform a method, the method comprising:
storing information about a plurality of digital cards such that even identical digital cards are uniquely identifiable;
storing information about card use, in which any one of the digital cards is used, in association with the used digital card; and
presenting, in response to receiving selection of any one of the digital cards, the information about the card use that is associated with the card.

2. The non-transitory computer-readable storage medium according to claim 1, wherein the information about the card use is information about a battle fought using a deck constructed by combining the cards.

3. The non-transitory computer-readable storage medium according to claim 2, wherein the information about the battle includes a date of the battle, a result of the battle, an opponent of the battle, information about a deck shuffle during the battle, information about the deck, or information about a tournament.

4. The non-transitory computer-readable storage medium according to claim 1, wherein the information about the card use is information about support for another user who uses a deck constructed using a digital card having the same effect as the digital card owned by a user.

5. The non-transitory computer-readable storage medium according to claim 4, wherein the information about the support includes another user using the deck, a result of a battle, an opponent of the battle, information about the deck, information about a tournament, or a result of the tournament.

6. The non-transitory computer-readable storage medium according to claim 1, wherein information about the plurality of digital cards is stored in a distributed ledger formed by a computer network.

7. The non-transitory computer-readable storage medium according to claim 6, wherein the information about the card use is stored as a transaction of the corresponding digital card in the distributed ledger.

8. The non-transitory computer-readable storage medium according to claim 6, wherein the information about the card use is information about a battle fought using a deck constructed by combining the cards, and
the information about the battle is stored as a transaction of the corresponding digital card in the distributed ledger.

9. The non-transitory computer-readable storage medium according to claim 6, wherein the information about the card use is information about support for another user who uses a deck constructed using a digital card having the same effect as the digital card owned by a user, and
the information about the support is stored as a transaction of the corresponding digital card in the distributed ledger.

10. The non-transitory computer-readable storage medium according to claim 1, further comprising:
storing information about trading of a digital card in association with the traded digital card.

11. The non-transitory computer-readable storage medium according to claim 10, wherein the information about the trading includes a date and time of transfer, a user as a transferer, a user as a transferee, or a value of transfer.

12. The non-transitory computer-readable storage medium according to claim 10, wherein the information about the trading is stored as a transaction of the traded digital card in the distributed ledger.

13. The non-transitory computer-readable storage medium according to claim 1, further comprising:
offering a bonus corresponding to information about the use.

14. The non-transitory computer-readable storage medium according to claim 13, wherein the information about the card use is information about a battle fought using a deck constructed by combining the cards,
the method further comprising:
offering a bonus corresponding to the information about the battle.

15. The non-transitory computer-readable storage medium according to claim 13, wherein the information about the card use is information about support for another user who uses a deck constructed using a digital card having the same effect as the digital card owned by a user,
the method further comprising:
offering a bonus corresponding to the information about the support.

16. A method, comprising:
storing information about a plurality of digital cards such that even identical digital cards are uniquely identifiable;
storing information about card use, in which any one of the plurality of digital cards is used, in association with the used digital card; and
presenting, in response to receiving selection of any one of the plurality of digital cards, the information about the card use that is associated with the card.

17. An information processing device, comprising:
processing circuitry configured to
store information about a plurality of digital cards such that even identical digital cards are uniquely identifiable,
store information about card use, in which any one of the plurality of digital cards is used, in association with the used digital card, and
present, when receiving selection of any one of the plurality of digital cards, the information about the card use that is associated with the card.

18. A system, comprising:
means for storing information about a plurality of digital cards such that even identical digital cards are uniquely identifiable;
means for storing information about card use, in which any one of the plurality of digital cards is used, in association with the used digital card; and
means for presenting, when receiving selection of any one of the plurality of digital cards, the information about the card use that is associated with the card.
